(19) United States
(12) Patent Application Publication
(10) Pub. No.: US 2025/0192903 A1
(43) Pub. Date: Jun. 12, 2025

(54) MECHANISM FOR POSITIONING ANOMALY DISCOVERY

(71) Applicant: Nokia Technologies Oy, Espoo (FI)

(72) Inventors: Oana-Elena BARBU, Aalborg (DK); Benny VEJLGAARD, Aalborg (DK); Ryan KEATING, Naperville, IL (US); Tao TAO, Shanghai (CN); Johannes HARREBEK, Aalborg (DK); Jan Torst HVIID, Aalborg (DK)

(21) Appl. No.: 18/844,253

(22) PCT Filed: Mar. 9, 2022
(86) PCT No.: PCT/CN2022/079972

§ 371 Date: Sep. 5, 2024

(51) Int. Cl. H04B 17/336; H04W 24/08; H04W 64/00

(52) U.S. Cl. CPC H04B 17/336; H04W 24/08; H04W 64/00

(57) ABSTRACT

Mechanism on positioning anomaly discovery is provided. According to embodiments of the present disclosure, a positioning element (PE) determines whether a positioning degradation is caused by a disruptive signal based on a signal profile. In this way, the cause of the positioning degradation can be determined accurately.

### FIELD

Embodiments of the present disclosure generally relate to communication techniques, and more particularly, to methods, devices and computer readable medium for disruptive signal discovery.

### BACKGROUND

Positioning is an important enabler for various verticals and use cases that the fifth generation (5G) system aims to support. By obtaining knowledge relating to approximate/precise position of devices, applications such as location-based services, autonomous driving, and industrial internet of thing (IoT) can be fulfilled by 5G system. Although accurate positioning typically could be fulfilled by global navigation satellite system (GNSS) techniques such as global positioning system (GPS), they may not be able to provide positioning with sufficient accuracy for indoor scenarios such as factory automation or warehouse management. Thus, radio access technology (RAT)-dependent positioning methods based on downlink/uplink signals should to be studied.

### SUMMARY

Generally, embodiments of the present disclosure relate to a method for positioning anomaly discovery and corresponding devices.

In a first aspect, there is provided a first device. The first device comprises at least one processor; and at least one memory including computer program codes; the at least one memory and the computer program codes are configured to, with the at least one processor, cause the first device to: in accordance with a determination of a trigger related to a positioning performance of a second device, determine, at a first device, a set of measured channel parameters based on a set of reference signals associated with the second device; compare the set of measured channel parameters with a set of reference channel parameters, wherein the set of reference channel parameters are obtained from a previous measurement which is associated with an anomaly-free signal; and determine whether an anomaly behavior occurs at the second device based on the comparison.

In a second aspect, there is provided a method. The method comprises in accordance with a determination of a trigger related to a positioning performance of a second device, determining, at a first device, a set of measured channel parameters based on a set of reference signals associated with the second device; comparing the set of measured channel parameters with a set of reference channel parameters, wherein the set of reference channel parameters are obtained from a previous measurement which is associated with an anomaly-free signal; and determining whether an anomaly behavior occurs at the second device based on the comparison.

In a third aspect, there is provided a computer readable medium comprising program instructions for causing an apparatus to perform at least the method according to the above first aspect.

It is to be understood that the summary section is not intended to identify key or essential features of embodiments of the present disclosure, nor is it intended to be used to limit the scope of the present disclosure. Other features of the present disclosure will become easily comprehensible through the following description.

### BRIEF DESCRIPTION OF THE DRAWINGS

Some example embodiments will now be described with reference to the accompanying drawings, where:

FIG. 1 illustrates a schematic diagram of a communication system according to according to embodiments of the present disclosure;

FIG. 2 illustrates a flow chart of a method according to some embodiments of the present disclosure;

FIG. 3 illustrates a clean signal envelope and a corrupted signal envelope according to some embodiments of the present disclosure;

FIG. 4A shows a flow chart of an example method for determining the cause of the positioning degradation according to some embodiments of the present discourse;

FIG. 4B shows a flow chart of an example method for determining the cause of the positioning degradation according to some embodiments of the present discourse;

FIG. 5 illustrates a simplified block diagram of an apparatus that is suitable for implementing embodiments of the present disclosure; and

FIG. 6 illustrates a block diagram of an example computer readable medium in accordance with some example embodiments of the present disclosure.

Throughout the drawings, the same or similar reference numerals represent the same or similar element.

### DETAILED DESCRIPTION

Principle of the present disclosure will now be described with reference to some example embodiments. It is to be understood that these embodiments are described only for the purpose of illustration and help those skilled in the art to understand and implement the present disclosure, without suggesting any limitation as to the scope of the disclosure. The disclosure described herein can be implemented in various manners other than the ones described below.

In the following description and claims, unless defined otherwise, all technical and scientific terms used herein have the same meaning as commonly understood by one of ordinary skills in the art to which this disclosure belongs.

References in the present disclosure to “one embodiment,” “an embodiment,” “an example embodiment,” and the like indicate that the embodiment described may include a particular feature, structure, or characteristic, but it is not necessary that every embodiment includes the particular feature, structure, or characteristic. Moreover, such phrases are not necessarily referring to the same embodiment. Further, when a particular feature, structure, or characteristic is described in connection with an example embodiment, it is submitted that it is within the knowledge of one skilled in the art to affect such feature, structure, or characteristic in connection with other embodiments whether or not explicitly described.

It shall be understood that although the terms “first” and “second” etc. may be used herein to describe various elements, these elements should not be limited by these terms. These terms are only used to distinguish one element from another. For example, a first element could be termed a second element, and similarly, a second element could be termed a first element, without departing from the scope of example embodiments. As used herein, the term “and/or” includes any and all combinations of one or more of the listed terms.

The terminology used herein is for the purpose of describing particular embodiments only and is not intended to be limiting of example embodiments. As used herein, the singular forms “a”, “an” and “the” are intended to include the plural forms as well, unless the context clearly indicates otherwise. It will be further understood that the terms “comprises”, “comprising”, “has”, “having”, “includes” and/or “including”, when used herein, specify the presence of stated features, elements, and/or components etc., but do not preclude the presence or addition of one or more other features, elements, components and/or combinations thereof.

As used in this application, the term “circuitry” may refer to one or more or all of the following:
(a) hardware-only circuit implementations (such as implementations in only analog and/or digital circuitry) and
(b) combinations of hardware circuits and software, such as (as applicable):
   (i) a combination of analog and/or digital hardware circuit(s) with software/firmware and
   (ii) any portions of hardware processor(s) with software (including digital signal processor(s)), software, and memory(ies) that work together to cause an apparatus, such as a mobile phone or server, to perform various functions) and
(c) hardware circuit(s) and or processor(s), such as a microprocessor(s) or a portion of a microprocessor(s), that requires software (e.g., firmware) for operation, but the software may not be present when it is not needed for operation.

This definition of circuitry applies to all uses of this term in this application, including in any claims. As a further example, as used in this application, the term circuitry also covers an implementation of merely a hardware circuit or processor (or multiple processors) or portion of a hardware circuit or processor and its (or their) accompanying software and/or firmware. The term circuitry also covers, for example and if applicable to the particular claim element, a baseband integrated circuit or processor integrated circuit for a mobile device or a similar integrated circuit in server, a cellular network device, or other computing or network device.

As used herein, the term “communication network” refers to a network following any suitable communication standards, such as Long Term Evolution (LTE), LTE-Advanced (LTE-A), Wideband Code Division Multiple Access (WCDMA), High-Speed Packet Access (HSPA), Narrow Band Internet of Things (NB-IoT), New Radio (NR) and so on. Furthermore, the communications between a terminal device and a network device in the communication network may be performed according to any suitable generation communication protocols, including, but not limited to, the first generation (1G), the second generation (2G), 2.5G, 2.75G, the third generation (3G), the fourth generation (4G), 4.5G, the future fifth generation (5G) communication protocols, and/or any other protocols either currently known or to be developed in the future. Embodiments of the present disclosure may be applied in various communication systems. Given the rapid development in communications, there will of course also be future type communication technologies and systems with which the present disclosure may be embodied. It should not be seen as limiting the scope of the present disclosure to only the aforementioned system.

As used herein, the term “network device” refers to a node in a communication network via which a terminal device accesses the network and receives services therefrom. The network device may refer to a base station (BS) or an access point (AP), for example, a node B (NodeB or NB), an evolved NodeB (eNodeB or eNB), a NR NB (also referred to as a gNB), a Remote Radio Unit (RRU), a radio header (RH), a remote radio head (RRH), a relay, a low power node such as a femto, a pico, and so forth, depending on the applied terminology and technology.

The term “terminal device” refers to any end device that may be capable of wireless communication. By way of example rather than limitation, a terminal device may also be referred to as a communication device, user equipment (UE), a Subscriber Station (SS), a Portable Subscriber Station, a Mobile Station (MS), or an Access Terminal (AT). The terminal device may include, but not limited to, a mobile phone, a cellular phone, a smart phone, voice over IP (VoIP) phones, wireless local loop phones, a tablet, a wearable terminal device, a personal digital assistant (PDA), portable computers, desktop computer, image capture terminal devices such as digital cameras, gaming terminal devices, music storage and playback appliances, vehicle-mounted wireless terminal devices, wireless endpoints, mobile stations, laptop-embedded equipment (LEE), laptop-mounted equipment (LME), USB dongles, smart devices, wireless customer-premises equipment (CPE), an Internet of Things (IoT) device, a watch or other wearable, a head-mounted display (HMD), a vehicle, a drone, a medical device and applications (e.g., remote surgery), an industrial device and applications (e.g., a robot and/or other wireless devices operating in an industrial and/or an automated processing chain contexts), a consumer electronics device, a device operating on commercial and/or industrial wireless networks, and the like. In the following description, the terms “terminal device”, “communication device”, “terminal”, “user equipment” and “UE” may be used interchangeably.

As mentioned above, radio access technology (RAT)-dependent positioning methods based on downlink/uplink signals should to be studied. 5G NR positioning integrity concerns have been raised and deserves investigation. Integrity represents information relating to “how much and/or how long the positioning estimation results can be trusted”. Note that the integrity concept is already an important element for conventional positioning methods based on GNSS and it is also an important system design aspect for applications that rely on accurate positioning (e.g. autonomous driving).

One of the main threats of NR positioning integrity is an attack (e.g., a physical layer attack, a disruptive attack, a malicious attack, and/or the like). An attack appears when another device disturbs the positioning session totally or partially, causing a severe degradation of the localization accuracy. In an attack, the target location is either faked or the network is prevented from acquiring it altogether. Such attacks are frequent in GNSS positioning and are a real threat for NR positioning integrity since they ultimately enable an illegal activity to be performed incognito. For the above reasons, an integrity framework that allows for the identification, detection and ultimately the eradication of an attack should be defined.

Positioning integrity is threatened by fraudulent or malicious devices that emit disruptive or malicious signals intended to disturb an ongoing communication and/or positioning session. The malicious signal is sent with different transmission patterns and aims at faking the appearance of the wireless channel/signal. In positioning, an attack attempts at blocking and/or faking positioning signals so that the network is prevented from acquiring a reliable target location, ultimately compromising the localization integrity. Therefore, the positioning integrity is compromised when a fraudulent device either: impersonates one or more transmitters, and by doing this implicitly fakes the location of the legitimate positioning transmitter, or purposely floods specific portions of the spectrum to degrade the signal to interference and noise ratio (SINR) of the positioning receiver. In either case, the end result is that the target location estimation has been compromised and cannot be trusted.

Although, there are some conventional countermeasures against attacks, new solutions deserve investigating. For example, according to some conventional technologies, the problem can be avoided by using an opportunistic spectrum usage, i.e. by frequency hopping. This approach is not an option in NR positioning where positioning resources need to be pre-scheduled and allocated across multiple cells to mitigate interference. According to some other conventional technologies, the malicious device can be localized by assuming prior information about the malicious activity is available at designated sensor nodes. This is an unrealistic assumption for NR positioning, since the 5G network is not currently equipped with any protocols that enable the detection of the attack.

In order to solve at least part of the above problems and other potential problems, solutions on positioning anomaly discovery are proposed. According to embodiments of the present disclosure, a positioning element (PE) determines whether a positioning degradation is caused by a disruptive signal based on a signal profile. In this way, the cause of the positioning degradation can be determined accurately.

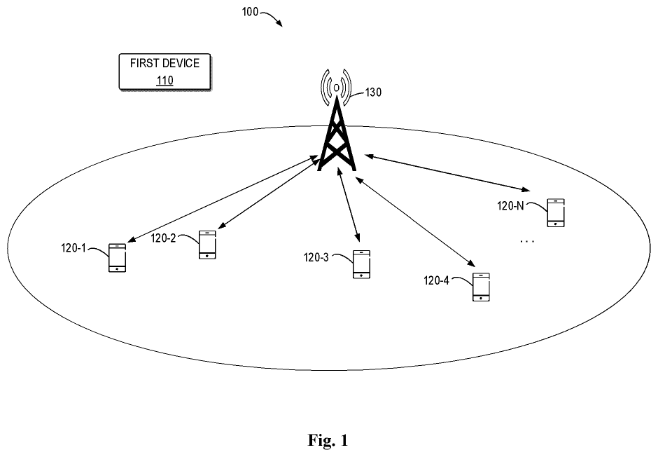

FIG. 1 illustrates a schematic diagram of a communication system in which embodiments of the present disclosure can be implemented. The communication system 100, which is a part of a communication network, comprises a core network device 110, for example, a location management function (IMF). The communication system also comprises a terminal device 120-1, a terminal device 120-2, a terminal device 120-3 . . . , a terminal device 120-N, which can be collectively referred to as “terminal device(s) 120.” The communication system 100 further comprises a network device 130. It is to be understood that the number of devices shown in FIG. 1 is given for the purpose of illustration without suggesting any limitations. The communication system 100 may comprise any suitable number of devices and cells. In the communication system 100, the devices 120 can communicate data and control information to each other.

Communications in the communication system 100 may be implemented according to any proper communication protocol(s), comprising, but not limited to, cellular communication protocols of the first generation (1G), the second generation (2G), the third generation (3G), the fourth generation (4G) and the fifth generation (5G) and on the like, wireless local network communication protocols such as Institute for Electrical and Electronics Engineers (IEEE) 802.11 and the like, and/or any other protocols currently known or to be developed in the future. Moreover, the communication may utilize any proper wireless communication technology, comprising but not limited to: Code Divided Multiple Address (CDMA), Frequency Divided Multiple Address (FDMA), Time Divided Multiple Address (TDMA), Frequency Divided Duplexer (FDD), Time Divided Duplexer (TDD), Multiple-Input Multiple-Output (MIMO), Orthogonal Frequency Divided Multiple Access (OFDMA) and/or any other technologies currently known or to be developed in the future.

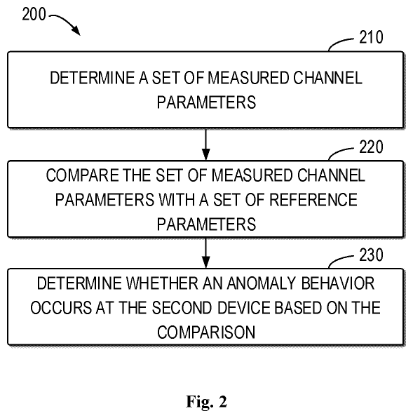

Example embodiments of the present disclosure will be described in detail below with reference to the accompanying drawings. Reference is now made to FIG. 2, which illustrates a flow chart of method 200 according to embodiments of the present disclosure. The method 200 can be implemented at a positioning element. The positioning element may be the core network device 110. Alternatively, the positioning element may be a terminal device, for example, the terminal device 120-1. In other embodiments, the positioning element may be a network device 130. In some embodiments, the positioning element may be directly involved in a positioning session. Alternatively, the positioning element may be indirectly involved in a positioning session, for example, a positioning reference unit (PRU). The term “positioning reference unit (PRU)” used herein can refer to a device or network node with reliable location that can be activated on demand by the LMF to perform specific positioning operations, for example, measurement and/or transmission of specific positioning signals.

In some embodiments, if the positioning element is the core network device 110, the positioning element may receive a location request for a second device from a location service client (LCS). The term “LCS client” used herein can refer to a software and/or hardware entity that interacts with a LCS Server for the purpose of obtaining location information for one or more Mobile Stations. In some embodiments, the second device may be a terminal device. For example, the second device can be any one of terminal devices 120. Only for the purpose of illustrations, the second device can refer to the terminal device 120-2 hereinafter. The LCS client can request from the positioning element in the public land mobile network (PLMN) location information for the second device within a specified set of parameters such as Quality of Service (QoS). The LCS Client may reside in an entity (including the UE) within the PLMN or in an entity external to the PLMN.

In some embodiments, the positioning element may determine whether the positioning degradation occurs by itself. For example, if the positioning element is the network device 130 or the core network device 110, the positioning element may determine whether the positioning degradation occurs by itself. Alternatively, the positioning element may receive an indication regarding the positioning degradation from other entities. For example, if the positioning element is the terminal device 120, the positioning element may receive such indication from the core network device 110 or the network device 130.

At block 210, if the positioning degradation of the second device occurs, the positioning element determines a set of measured channel parameters based on a set of reference signals associated with the second device. In some embodiments, if the positioning element can revive the set of reference signals, the positioning element may determine the set of measured channel parameters based on the set of reference signals. Alternatively, if the positioning element cannot revive the set of reference signals, the positioning element may receive information indicating the set of measured channel parameters from other entities or devices.

In some embodiments, the positioning element may compute a likelihood that the positioning integrity of the second device has been compromised. The positioning element may collect data from the latest positioning sessions of the second device and information about traffic of the second device in the serving cell from the serving network device of the second device.

In some embodiments, the set of measured channel parameters may comprise channel state information of the serving cell and/or the neighbor cell of the second device. The term “channel state information (CSI)” used herein can refer to channel properties of a communication link. This information describes how a signal propagates from the transmitter to the receiver and represents the combined effect of, for example, scattering, fading, and power decay with distance. Alternatively or in addition, the set of measured channel parameters may comprise a co-channel interference level of the serving cell and/or the neighbor cell. In some other embodiments, the set of measured channel parameters may comprise a cross-link interference level of the serving cell and/or the neighbor cell. In some embodiments, the positioning element may also obtain a mobility profile of the second device. For example, the mobility profile may comprise a handover history and rate of the second device. The mobility profile may also comprise other information which indicates how the second device moves.

In some embodiments, the positioning element may receive data about a positioning quality of service (QoS) of the second device. For example, the data may comprise an estimated position uncertainty value. As an example, such error may be quantified by the position estimate variance, or abnormal time of arrive (TOA)/reference signal time difference (RSTD variation between two consecutive estimates. For example, the differential TOA between consecutive measurements may be computed and compared against a threshold relative to a maximum UE speed. In this case, if the differential TOA is larger than a threshold which may be proportional to the speed of the device, this indicates a potential error.

In some embodiments, the data about the positioning QoS may a link quality of the network device 130. For example, the link quality may comprise a reference signal received power (RSRP) associated with the network device 130. Alternatively, the link quality may comprise a signal to noise ratio (SNR) associated with the network device 130. In other embodiments, the link quality may comprise a line of sight (LOS) probability. It should be noted that the link quality may be indicated by any proper parameter.

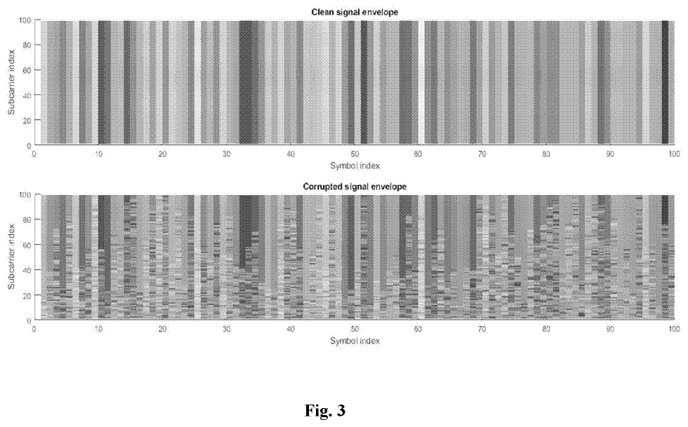

Alternatively or in addition, the data about the positioning QoS may comprise a carrier of the network device 130. The data about the positioning QoS may also comprise a bandwidth of the network device 130. In some embodiments, the data about the positioning QoS may comprise a vector of samples per transmission reception point of a signal received at the second device. For example, the data about the positioning QoS may comprise a vector of K samples per TRP 1 of the received signal after post-processing (for example, cross-correlation with the known transmitting sequence), specifically the K strongest samples: [rₗ(1), . . . , rₗ(k)]. For example, FIG. 3 shows a snapshot of the received signal.

The set of measured channel parameters may comprise a set of parameters describing channel characteristics. For example, the set of measured channel parameters may comprise one or more of: a first parameter describing a channel characteristic in space domain, a second parameter describing a channel characteristic in time domain, or a third parameter describing a channel characteristic in frequency domain. For example, the set of measured channel parameters may comprise a line of sight indication. Alternatively, the set of measured channel parameters may comprise a line of sight probability. In some embodiments, the set of measured channel parameters may comprise a maximum excess delay. In other embodiments, the set of measured channel parameters may comprise coherence time. In some other embodiment, the set of measured channel parameters may comprise a coherence bandwidth.

In some embodiments, the positioning element may receive a first channel profile of the second device towards a neighbor cell. For example, the first channel profile may comprise a carrier frequency of the neighbor cell of the second device. The first channel profile may comprise a bandwidth.

Alternatively or in addition, the first channel profile may comprise a maximum frequency shift. For example, the maximum frequency shift may indicate a Doppler shift. For example, the maximum frequency shift may indicate a total frequency shift, i.e, a sum of the doppler shift and a carrier frequency offset (CFO). The frequency offset may contain other components as well.

In other embodiments, the first channel profile may indicate a serving beam index of the neighbor cell. In some embodiments, the first channel profile may indicate a link quality of the neighbor cell. For example, the link quality may comprise a reference signal received power (RSRP) associated with the neighbor cell. Alternatively, the link quality may comprise a signal to interference and noise ratio (SINR) associated with the neighbor cell. In other embodiments, the link quality may comprise a line of sight (LOS) probability. It should be noted that the link quality may be indicated by any proper parameter. The first channel profile may also comprise a traffic direction indicator. For example, if the traffic direction indicator is “1”, it means that the traffic is UL traffic. If the traffic direction indicator is “0”, it means that the traffic is DL traffic.

Alternatively or in addition, the first channel profile may comprise a cross-link interference (CLI) level c. CLI may occur when the DL of the second device is being interfered by the UL of a UE which is served by a neighbor cell and may be called aggressor. Note that 5G NR has defined a framework for the serving cell to quantize the level of CLI and identify the sources of CLI using specific UL and DL reference signals. The first channel profile may comprise a total number of CLI aggressors T_{c}.

In some embodiments, the first channel profile may comprise a co-channel interference (CCI) indicator C. CCI may occur when the UL of the second device is interfered by a transmission of a neighbor cell.

The first channel profile may comprise map information of a region where the second device locates. For example, the map information may comprise a channel radio map from raytracing results. Alternatively, the map information may comprise main reflectors positions.

In some embodiments, the positioning element may determine whether the positioning degradation for the second device is caused by an interference which is not associated with an anomaly behavior. For example, the positioning element may determine the cause of the positioning degradation based on an estimated SINR and an observed SINR. Alternatively, the positioning element may determine the cause of the positioning degradation using a processor to distinguish between a co-channel or cross-channel interference and other types of spectral blockages.

For example, if the estimated position uncertainty value is above a threshold value, the positioning element may determine a second channel profile of the second device towards a serving cell. In this case, the positioning element may determine whether the positioning degradation for the second device is caused by an interference based on the second channel profile and a mobility profile of the second device.

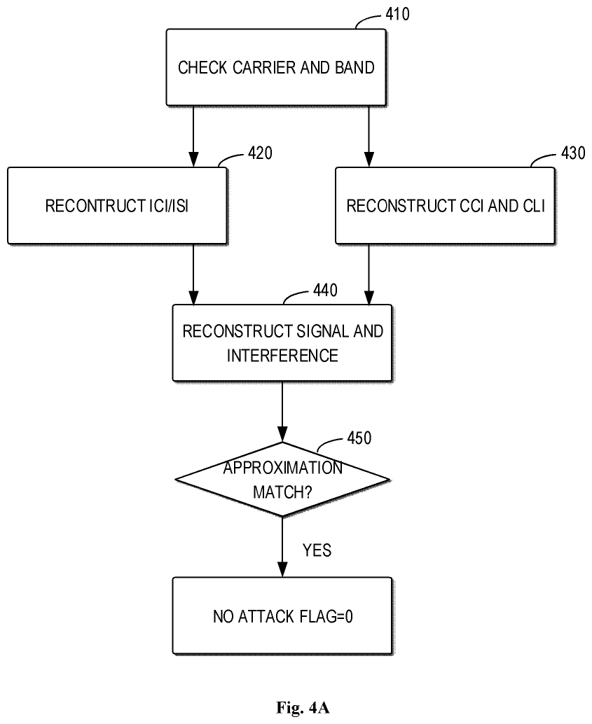

FIG. 4A shows a flow chart of an example method for determining the cause of the positioning degradation according to some embodiments of the present discourse.

At block 410, the positioning element may check the carrier and band of a TRP (for example, the network device 130) is used. After determining that the carrier and band is used, the positioning element may reconstruct inter carrier interference (ICI)/inter symbol interference (ISI) of the TRP and the CCI and CLI of the TRP. For example, at block 420, the positioning element may reconstruct the ICI/ISI based on the mobility profile of the second device. Only as an example, the mobility profile of the second device may comprise the maximum frequency shift.

At block 430, the positioning element may reconstruct CCI and CLI. For example, as mentioned above, the first channel profile may comprise the CLI level, the CCI indicator, the total number of CLI aggressors. In this case, the positioning element may reconstruct CCI and CLI based on the first channel profile.

At block 440, the positioning element may reconstruct the signal and interference based on at least one of: the ICI/ISI, the CCI, the CLI, or the link quality. For example, the positioning element may reconstruct an expected SINR level by additionally: assuming that the channel coherence time is larger than the time interval between the two measurements and knowing the positioning reference signal (PRS) muting pattern. The PRS muting pattern may indicate occasions when the TRPs are interrupting their PRS transmission, and scaling the SINR values accordingly.

At block 450, the positioning element may determine whether the SINR matches an approximation. For example, if the SINR matches with that reported for the 1-th positioning session, then the positioning element may conclude that an attack is unlikely by returning the flag=0. In other words, the SINR matches with that reported for the 1-th positioning session, there is no anomaly behavior at the second device. Alternatively, if the SINR does not match with that reported for the 1-th positioning session, then the positioning element may conclude that an attack is unlikely by returning the flag=1. In other words, the SINR does not with that reported for the 1-th positioning session, there may be anomaly behavior at the second device.

In some embodiments, the network device 130 may be aware of CCI and CLI and have estimated the mobility profile of the second device. In this case, the network device 130 may trigger the positioning element to skip the determination of the cause which comprises the co-channel interference and cross-link interference. In other words, the steps 410-450 shown in FIG. 4A can be skipped.

Referring back to block 220, the positioning element compares the set of measured channel parameters with a set of reference channel parameters. The set of reference channel parameters are obtained from a previous measurement which is associated with an anomaly-free signal.

In some embodiments, the positioning element may compare the set of measured channel parameters with the set of reference channel parameters based on a probability density function associated with the set of reference channel parameters. In some embodiments, the positioning element may compare the set of measured channel parameters with the set of reference channel parameters based on a test function which tracks time variation of the set of reference channel parameters. Alternatively, the positioning element may compare the set of measured channel parameters with the set of reference channel parameters using a supervised learning block.

At block 240, the positioning element determines whether an anomaly behavior occurs at the second device based on the comparison. The term “anomaly behavior” or “anomaly” used herein can refer to a behavior or pattern that does not conform to a regular behavior. In other words, it means that the instantaneous value of a (set of) signal measurement is (are) not matching a distribution obtained from past measurements associated with anomaly-free positioning events. The anomaly detection can be a step in data mining that identifies data points, events, and/or observations that deviate from a dataset's normal behavior.

In some embodiments, the positioning element may determine whether an anomaly behavior occurs at the second device by applying a goodness-of-fit test. Alternatively, the positioning element may determine whether an anomaly behavior occurs at the second device by a time-series analysis. In other embodiments, such determination can be made by applying machine learning.

As mentioned above, the positioning element may first determine whether the positioning degradation is caused by know reasons. In this case, if the positioning element determines that the positioning degradation is not caused by know reasons, the positioning element may further determine whether the anomaly behavior occurs at the second device. For example, if there is not sufficient information to match the SINR, the positioning element may trigger an analysis of the signal profile. Specifically, the complex samples rₗ are being extracted from memory for a time window X (X chosen smaller than or equal to the channel coherence time), where each instance corresponds to a past positioning session, e.g. PRS occurrence. Alternatively, the positioning element may directly determine whether the anomaly behavior occurs at the second device without the determination of the known reasons.

In some embodiments, a probability density function (PDF) which relates to a measurement of a clean signal may be used. For example, an empirical PDF for the envelope and main delays of the signal rₗ may be computed using all past X−1 samples that have been tagged as anomaly-free. The term “a probability density function (PDF)” used herein can refer to a statistical expression that defines a probability distribution (the likelihood of an outcome) for a discrete random variable as opposed to a continuous random variable.

For example, as shown in FIG. 4B, the input signal may be signal rₗ(t), . . . , rₗ(t−X). At block 460, the positioning element may perform time-to frequency transform on the signal. At block 462, the positioning element may determine power per frequency bin extraction. At block 464, the positioning element may determine the PDF associated with power for past X−1 instance. At block 470, the positioning element may perform the first tap delay extraction. At block 475, the positioning element may determine the PDF associated with delay 1 for past X−1 instance. At block 480, the positioning element may perform the second tap delay extraction. At block 485, the positioning element may determine the PDF associated with delay 2 for past X−1 instance. At block 490, the positioning element may determine whether the power per pin, the delay 1 and the delay 2 at time instant 1 belong to their respective PDFs. In some embodiments, such determination may be based on a goodness-of-fit method (for example, Kolmogorov-Smirnov test, method of L-moments). If the main delays and the power per bin are matching with the respective empirical distributions, then the positioning element may conclude that there is no attack and returns the flag=0, which means that the anomaly behavior does not at the second device. Alternatively, the positioning element may conclude the attack is likely and returns flag=1, which means that the anomaly behavior occurs at the second device. In some other embodiments, the goodness-of-fit testing can return an attack probability p_{attack}∈[0,1]instead of a binary flag, where p_{attack}=0 means no attack has been detected.

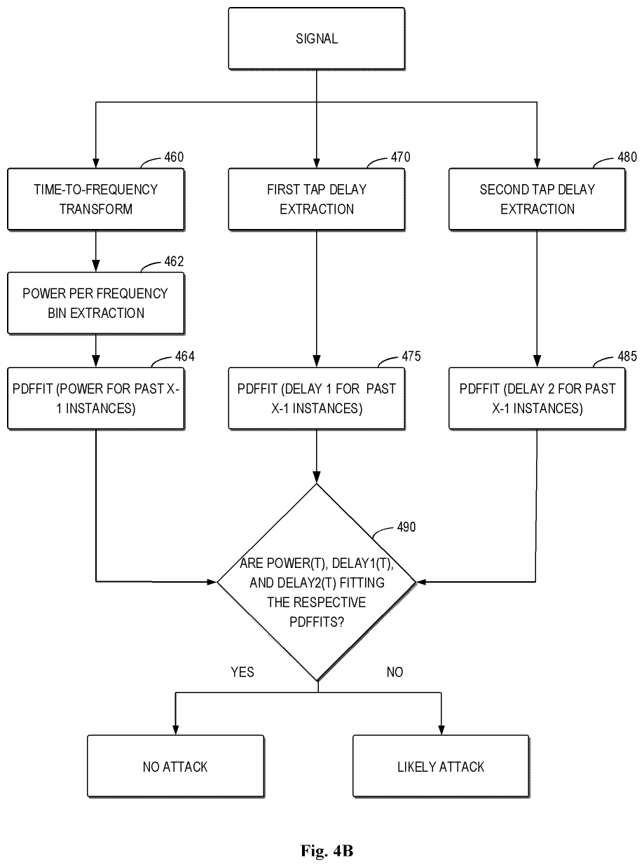

In some embodiments, the pdfFit may be replaced by other tests tracking the time variation of these parameters for the same observation window X. For example, as shown in FIG. 5, if there is a mismatch between the time instance x1 associated with a change in pattern of total power and the time instance x2 associated with a change in pattern of each of the selected Y delays (e.g. Y=2), the positioning element may determine that the anomaly behavior occurs at the second device. In some embodiments, there may be a mismatch between an expected parameter (as obtained from time series analysis of the values observed in the past) and the instantaneous estimate. For example, delays estimation may be done on a per symbol basis (e.g., in comb 6 come up with 6 different ToA). If the SNR is high, then the six ToAs may be expected to be relatively close to each other and any other behavior is indicative of an attack.

Alternatively, as mentioned above, the positioning element may determine whether an anomaly behavior occurs at the second device by applying machine learning. For example, a supervised learning block may be implemented as: a classifier, and hence that outputs a binary flag indicating the presence (1) or absence (0) of an attack; a regressor which outputs an attack probability p_{attack}∈[0, 1]. Alternatively, the block may output an indicator {1, 2, . . . , k, . . . }, where the index designates the type of the malicious signal (see the types defined below).

In some other embodiments, the supervised learning block may take as input the same signal samples over the same observation window of duration X and be implemented as e.g. a decision forest, convolutional neural network, deep neural network, etc. with a softmax or sigmoid activation function. In this case, to train the network, artificial signal samples r may be generated in a simulator in a multi-step approach: (1) generating a clean positioning reference signal with various SNR levels, e.g. [SNRlow, SNRhigh], e.g. SNRlow=−13 dB, SNRhigh=6 dB; (2) generating a disruptive signal of different types; (3) generating the received signal by superimposing a clean signal with the disruptive signal and (4) tagging the signal obtained in steps (2) and (3).

In some embodiments, the disruptive signal may be of at least type: type 1: random signal in time and frequency: the malicious device is sending random signals on random physical resource blocks (PRBs) (and subsequently it is silent in random PRBs) with full power; type 2: continuous in time: the malicious device is sending a random signal at all time instances, but in random subcarriers with full power; type 3: continuous in frequency: the malicious device is sending a random signal at all subcarriers, but at random time instances, with full power; type 4: reactive/power boosting: the malicious device is sending a random signal on all PRBs, at all time instances, but the power from one instance to the other increases either linearly, exponentially, or by a different law. In some embodiments, the signal pool may be split into at least a train and test sets e.g. 30% for test, 70% training.

In some embodiments, the received signal may be generated by superimposing a clean signal with one, two, or three of the malicious signals above: Option 1: clean signal+1 random malicious signal of any type; Option 2: clean signal+2 random malicious signals of any type; Option 3: clean signal+3 random malicious signals of any type.

In some other embodiments, the signals obtained in steps 2 and 3 may be tagged with a binary label. for example, signal at step 2 with attack flag=0, signal at step 3 with attack flag=1.

In some embodiments, if the positioning element is the network device 130, the positioning element may transmit the indication regarding the anomaly behavior via backhaul (for example, via NR positioning protocol A (NRPPa) interface). In some embodiments, the indication may be a binary flag. For example, if the anomaly is detected, the binary flag may be “1.”

In some embodiments, an apparatus for performing the method 200 (for example, the core network device 110, the terminal device 120 or the network device 130) may comprise respective means for performing the corresponding steps in the method 500. These means may be implemented in any suitable manner. For example, it can be implemented by circuitry or software modules.

In some embodiments, the apparatus comprises means for in accordance with a determination of a trigger related to a positioning performance of a second device, determining, at a first device, a set of measured channel parameters based on a set of reference signals associated with the second device; means for comparing the set of measured channel parameters with a set of reference channel parameters, wherein the set of reference channel parameters are obtained from a previous measurement which is associated with an anomaly-free signal; and means for determining whether an anomaly behavior occurs at the second device based on the comparison.

In some embodiments, the apparatus further comprises means for receiving data about a positioning quality of service of the second device, wherein the data comprises at least one of: an estimated position uncertainty value, a first carrier frequency of a transmission reception point, a first bandwidth of the transmission reception point, a first link quality between the second device and the transmission reception point, or a vector of samples per transmission reception point of a signal received at the second device.

In some embodiments, the apparatus further comprises means for receiving a first channel profile of the second device towards a neighbor cell, wherein the first channel profile comprises at least one of: a second carrier frequency of the neighbor cell, a second bandwidth of the neighbor cell, a maximum frequency shift of the neighbor cell, a serving beam index of the neighbor cell, a link quality of the neighbor cell, a traffic direction indicator of the neighbor cell, a cross-link interference level of the neighbor cell, a total number of cross-link interference aggressors, a co-channel interference indicator of the neighbor cell, or map information of a region where the second device locates.

In some embodiments, the apparatus further comprises means for in accordance with a determination that an estimated position uncertainty value is above a threshold value, determining a second channel profile of the second device towards a serving cell; and means for determining, based on the second channel profile and a mobility profile of the second device, whether the positioning degradation for the second device is caused by an interference which is not associated with the anomaly behavior.

In some embodiments, the means for determining whether the positioning degradation for the second device is caused by the interference comprises: means for determining a signal to interference and noise ratio (SINR) based on the second channel profile and the mobility profile of the second device; means for in accordance with a determination that the SINR matches with a predetermined SINR, determining that the positioning degradation for the second device is caused by the interference; or means for in accordance with a determination that the SINR does not match with a predetermined SINR, determining that the positioning degradation for the second device is not caused by the interference.

In some embodiments, the means for determining whether the anomaly behavior occurs at the second device based on the comparison comprises: means for in accordance with a determination that a distribution of the set of measured channel parameters matches with a distribution of the set of reference channel parameters, determining that the anomaly behavior occurs at the second device; or means for in accordance with a determination that a distribution of the set of measured channel parameters does not match with a distribution of the set of reference channel parameters, determining that the anomaly behavior does not occur at the second device.

In some embodiments, the set of measured channel parameters comprises at least one of: a first parameter describing a channel characteristic in space domain, a second parameter describing a channel characteristic in time domain, or a third parameter describing a channel characteristic in frequency domain.

In some embodiments, the means for comparing the set of measured channel parameters with the set of reference channel parameters comprises one of: means for comparing the set of measured channel parameters with the set of reference channel parameters based on a probability density function associated with the set of reference channel parameters; or means for comparing the set of measured channel parameters with the set of reference channel parameters based on a test function which tracks time variation of the set of reference channel parameters.

In some embodiments, the first device comprises one of: a location management function, a transmission point, a terminal device, or a positioning reference unit.

FIG. 5 is a simplified block diagram of a device 500 that is suitable for implementing embodiments of the present disclosure. The device 500 may be provided to implement the communication device, for example, the core network device 110, the terminal device 120, or the network device 130 as shown in FIG. 1. As shown, the device 500 includes one or more processors 510, one or more memories 520 coupled to the processor 510, and one or more communication modules 540 coupled to the processor 510.

The communication module 540 is for bidirectional communications. The communication module 540 has at least one antenna to facilitate communication. The communication interface may represent any interface that is necessary for communication with other network elements.

The processor 510 may be of any type suitable to the local technical network and may include one or more of the following: general purpose computers, special purpose computers, microprocessors, digital signal processors (DSPs) and processors based on multicore processor architecture, as non-limiting examples. The device 500 may have multiple processors, such as an application specific integrated circuit chip that is slaved in time to a clock which synchronizes the main processor.

The memory 520 may include one or more non-volatile memories and one or more volatile memories. Examples of the non-volatile memories include, but are not limited to, a Read Only Memory (ROM) 524, an electrically programmable read only memory (EPROM), a flash memory, a hard disk, a compact disc (CD), a digital video disk (DVD), and other magnetic storage and/or optical storage. Examples of the volatile memories include, but are not limited to, a random access memory (RAM) 522 and other volatile memories that will not last in the power-down duration.

A computer program 530 includes computer executable instructions that are executed by the associated processor 510. The program 530 may be stored in the ROM 524. The processor 510 may perform any suitable actions and processing by loading the program 530 into the RAM 522.

The embodiments of the present disclosure may be implemented by means of the program 520 so that the device 500 may perform any process of the disclosure as discussed with reference to FIGS. 2 and 4B. The embodiments of the present disclosure may also be implemented by hardware or by a combination of software and hardware.

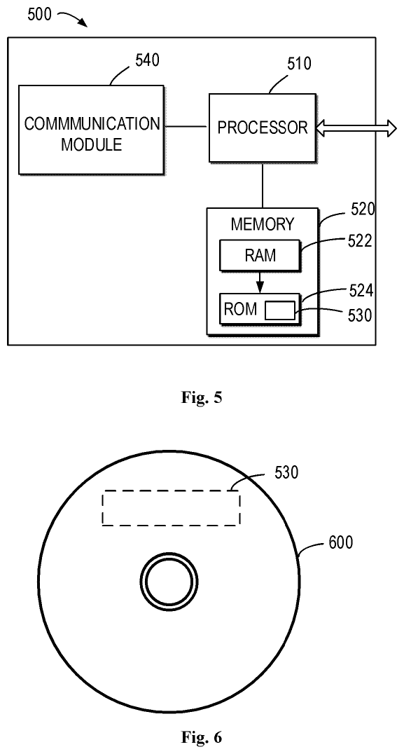

In some example embodiments, the program 530 may be tangibly contained in a computer readable medium which may be included in the device 500 (such as in the memory 520) or other storage devices that are accessible by the device 500. The device 500 may load the program 530 from the computer readable medium to the RAM 522 for execution. The computer readable medium may include any types of tangible non-volatile storage, such as ROM, EPROM, a flash memory, a hard disk, CD, DVD, and the like. FIG. 6 shows an example of the computer readable medium 600 in form of CD or DVD. The computer readable medium has the program 530 stored thereon.

Generally, various embodiments of the present disclosure may be implemented in hardware or special purpose circuits, software, logic or any combination thereof. Some aspects may be implemented in hardware, while other aspects may be implemented in firmware or software which may be executed by a controller, microprocessor or other computing device. While various aspects of embodiments of the present disclosure are illustrated and described as block diagrams, flowcharts, or using some other pictorial representations, it is to be understood that the block, apparatus, system, technique or method described herein may be implemented in, as non-limiting examples, hardware, software, firmware, special purpose circuits or logic, general purpose hardware or controller or other computing devices, or some combination thereof.

The present disclosure also provides at least one computer program product tangibly stored on a non-transitory computer readable storage medium. The computer program product includes computer-executable instructions, such as those included in program modules, being executed in a device on a target real or virtual processor, to carry out the methods as described above with reference to FIGS. 2-4B. Generally, program modules include routines, programs, libraries, objects, classes, components, data structures, or the like that perform particular tasks or implement particular abstract data types. The functionality of the program modules may be combined or split between program modules as desired in various embodiments. Machine-executable instructions for program modules may be executed within a local or distributed device. In a distributed device, program modules may be located in both local and remote storage media.

Program code for carrying out methods of the present disclosure may be written in any combination of one or more programming languages. These program codes may be provided to a processor or controller of a general purpose computer, special purpose computer, or other programmable data processing apparatus, such that the program codes, when executed by the processor or controller, cause the functions/operations specified in the flowcharts and/or block diagrams to be implemented. The program code may execute entirely on a machine, partly on the machine, as a stand-alone software package, partly on the machine and partly on a remote machine or entirely on the remote machine or server.

In the context of the present disclosure, the computer program codes or related data may be carried by any suitable carrier to enable the device, apparatus or processor to perform various processes and operations as described above. Examples of the carrier include a signal, computer readable medium, and the like.

The computer readable medium may be a computer readable signal medium or a computer readable storage medium. A computer readable medium may include but not limited to an electronic, magnetic, optical, electromagnetic, infrared, or semiconductor system, apparatus, or device, or any suitable combination of the foregoing. More specific examples of the computer readable storage medium would include an electrical connection having one or more wires, a portable computer diskette, a hard disk, a random access memory (RAM), a read-only memory (ROM), an erasable programmable read-only memory (EPROM or Flash memory), an optical fiber, a portable compact disc read-only memory (CD-ROM), an optical storage device, a magnetic storage device, or any suitable combination of the foregoing.

Further, while operations are depicted in a particular order, this should not be understood as requiring that such operations be performed in the particular order shown or in sequential order, or that all illustrated operations be performed, to achieve desirable results. In certain circumstances, multitasking and parallel processing may be advantageous. Likewise, while several specific implementation details are contained in the above discussions, these should not be construed as limitations on the scope of the present disclosure, but rather as descriptions of features that may be specific to particular embodiments. Certain features that are described in the context of separate embodiments may also be implemented in combination in a single embodiment. Conversely, various features that are described in the context of a single embodiment may also be implemented in multiple embodiments separately or in any suitable sub-combination.

Although the present disclosure has been described in languages specific to structural features and/or methodological acts, it is to be understood that the present disclosure defined in the appended claims is not necessarily limited to the specific features or acts described above. Rather, the specific features and acts described above are disclosed as example forms of implementing the claims.

1. A first device comprising:
at least one processor; and
at least one memory including computer program codes;
the at least one memory and the computer program codes are configured to, with the at least one processor, cause the first device to:
in accordance with a determination of a trigger related to a positioning performance of a second device, determine a set of measured channel parameters based on a set of reference signals associated with the second device;
compare the set of measured channel parameters with a set of reference channel parameters, wherein the set of reference channel parameters are obtained from a previous measurement which is associated with an anomaly-free signal; and
determine whether an anomaly behavior occurs at the second device based on the comparison.

2. The first device of claim 1, wherein the at least one memory and the computer program code are configured to, with the at least one processor, further cause the first device to:
receive data about a positioning quality of service of the second device, wherein the data comprises at least one of:
an estimated position uncertainty value,
a first carrier frequency of a transmission reception point,
a first bandwidth of the transmission reception point,
a first link quality between the second device and the transmission reception point, or
a vector of samples per transmission reception point of a signal received at the second device.

3. The first device of claim 1, wherein the at least one memory and the computer program code are configured to, with the at least one processor, further cause the first device to:
receive a first channel profile of the second device towards a neighbor cell, wherein the first channel profile comprises at least one of:
a second carrier frequency of the neighbor cell,
a second bandwidth of the neighbor cell,
a maximum frequency shift of the neighbor cell,
a serving beam index of the neighbor cell,
a link quality of the neighbor cell,
a traffic direction indicator of the neighbor cell,
a cross-link interference level of the neighbor cell,
a total number of cross-link interference aggressors,
a co-channel interference indicator of the neighbor cell, or
map information of a region where the second device locates.

4. The first device of claim 1, wherein the at least one memory and the computer program code are configured to, with the at least one processor, further cause the first device to:
in accordance with a determination that an estimated position uncertainty value is above a threshold value, determine a second channel profile of the second device towards a serving cell; and
determine, based on the second channel profile and a mobility profile of the second device, whether the positioning degradation for the second device is caused by an interference which is not associated with the anomaly behavior.

5. The first device of claim 4, wherein the at least one memory and the computer program code are configured to, with the at least one processor, cause the first device to determine whether the positioning degradation for the second device is caused by the interference by:
determining a signal to interference and noise ratio (SINR) based on the second channel profile and the mobility profile of the second device;
in accordance with a determination that the SINR matches with a predetermined SINR, determining that the positioning degradation for the second device is caused by the interference; or
in accordance with a determination that the SINR does not match with a predetermined SINR, determining that the positioning degradation for the second device is not caused by the interference.

6. The first device of claim 1, wherein the at least one memory and the computer program code are configured to, with the at least one processor, cause the first device to determine whether the anomaly behavior occurs at the second device based on the comparison by:
in accordance with a determination that a distribution of the set of measured channel parameters matches with a distribution of the set of reference channel parameters, determining that the anomaly behavior occurs at the second device; or
in accordance with a determination that a distribution of the set of measured channel parameters does not match with a distribution of the set of reference channel parameters, determining that the anomaly behavior does not occur at the second device.

7. The first device of claim 1, wherein the set of measured channel parameters comprises at least one of:
a first parameter describing a channel characteristic in space domain,
a second parameter describing a channel characteristic in time domain, or
a third parameter describing a channel characteristic in frequency domain.

8. The first device of claim 1, wherein the at least one memory and the computer program code are configured to, with the at least one processor, cause the first device to compare the set of measured channel parameters with the set of reference channel parameters by one of:
comparing the set of measured channel parameters with the set of reference channel parameters based on a probability density function associated with the set of reference channel parameters; or
comparing the set of measured channel parameters with the set of reference channel parameters based on a test function which tracks time variation of the set of reference channel parameters.

9. The first device of claim 1, wherein the first device comprises one of:
a location management function,
a transmission point,
a terminal device, or
a positioning reference unit.

10. A method, comprising:
in accordance with a determination of a trigger related to a positioning performance of a second device, determining, at a first device, a set of measured channel parameters based on a set of reference signals associated with the second device;
comparing the set of measured channel parameters with a set of reference channel parameters, wherein the set of reference channel parameters are obtained from a previous measurement which is associated with an anomaly-free signal; and
determining whether an anomaly behavior occurs at the second device based on the comparison.

11. The method of claim 10, further comprising:
receiving data about a positioning quality of service of the second device, wherein the data comprises at least one of:
an estimated position uncertainty value,
a first carrier frequency of a transmission reception point,
a first bandwidth of the transmission reception point,
a first link quality between the second device and the transmission reception point, or
a vector of samples per transmission reception point of a signal received at the second device.

12. The method of claim 10, further comprising:
receiving a first channel profile of the second device towards a neighbor cell, wherein the first channel profile comprises at least one of:
a second carrier frequency of the neighbor cell,
a second bandwidth of the neighbor cell,
a maximum frequency shift of the neighbor cell,
a serving beam index of the neighbor cell,
a link quality of the neighbor cell,
a traffic direction indicator of the neighbor cell,
a cross-link interference level of the neighbor cell,
a total number of cross-link interference aggressors,
a co-channel interference indicator of the neighbor cell, or
map information of a region where the second device locates.

13. The method of claim 10, further comprising:
in accordance with a determination that an estimated position uncertainty value is above a threshold value, determining a second channel profile of the second device towards a serving cell; and
determining, based on the second channel profile and a mobility profile of the second device, whether the positioning degradation for the second device is caused by an interference which is not associated with the anomaly behavior.

14. The method of claim 13, wherein determining whether the positioning degradation for the second device is caused by the interference comprises:
determining a signal to interference and noise ratio (SINR) based on the second channel profile and the mobility profile of the second device;
in accordance with a determination that the SINR matches with a predetermined SINR, determining that the positioning degradation for the second device is caused by the interference; or
in accordance with a determination that the SINR does not match with a predetermined SINR, determining that the positioning degradation for the second device is not caused by the interference.

15. The method of claim 10, wherein determining whether the anomaly behavior occurs at the second device based on the comparison comprises:
in accordance with a determination that a distribution of the set of measured channel parameters matches with a distribution of the set of reference channel parameters, determining that the anomaly behavior occurs at the second device; or
in accordance with a determination that a distribution of the set of measured channel parameters does not match with a distribution of the set of reference channel parameters, determining that the anomaly behavior does not occur at the second device.

16. The method of claim 10, wherein the set of measured channel parameters comprises at least one of:
a first parameter describing a channel characteristic in space domain,
a second parameter describing a channel characteristic in time domain, or
a third parameter describing a channel characteristic in frequency domain.

17. The method of claim 10, wherein comparing the set of measured channel parameters with the set of reference channel parameters comprises one of:
comparing the set of measured channel parameters with the set of reference channel parameters based on a probability density function associated with the set of reference channel parameters; or
comparing the set of measured channel parameters with the set of reference channel parameters based on a test function which tracks time variation of the set of reference channel parameters.

18. The method of claim 10, wherein the first device comprises one of:
a location management function,
a transmission point,
a terminal device, or
a positioning reference unit.

19. A computer readable storage medium comprising program instructions stored thereon, the instructions, when executed by an apparatus, causing the apparatus to perform the method of claim 10.

20. (canceled)
